(19) United States
(12) Patent Application Publication
(10) Pub. No.: US 2013/0333269 A1
(43) Pub. Date: Dec. 19, 2013

(54) Limb Line Fishing Device

(71) Applicant: Arthur I. Preller, JR., Augusta, AR (US)

(72) Inventor: Arthur I. Preller, JR., Augusta, AR (US)

(21) Appl. No.: 13/905,507

(22) Filed: May 30, 2013

Related U.S. Application Data
(60) Provisional application No. 61/658,982, filed on Jun. 13, 2012.

(51) Int. Cl. A01K 97/12

(52) U.S. Cl. CPC A01K 97/12
USPC 43/17

(57) ABSTRACT

A limb line fishing device having a length of fishing line and a hollow indicator tube, wherein the indicator tube slidably receives the fishing line. The indicator tube can be used to determine at a distance whether a fish has been caught. The fishing device is capable of securing a reusable line and a hook when the device is not in use.

### CROSS-REFERENCE TO RELATED APPLICATIONS

This application claims the benefit of U.S. Provisional Application No. 61/658,982, entitled “Limb Line Fishing Device” and filed on Jun. 13, 2012. The complete disclosure of said provisional patent application is hereby incorporated by reference.

### STATEMENT REGARDING FEDERALLY SPONSORED RESEARCH OR DEVELOPMENT

Not applicable

### BACKGROUND OF THE INVENTION

1. Field of the Invention

The present invention relates generally to a fishing device and, more particularly, to a limb line fishing device.

2. Brief Description of the Related Art

As an alternative to traditional fishing methods utilizing a fishing pole comprising a rod and a reel, fisherman also use a fishing method called limb lining. Limb lining involves tying one end of a fishing line or rope to a limb while the other end is tied to a hook. The hook is baited and lowered into the water. Typically, fishermen set multiple limb lines in a given area and return at a later time to check to see if a fish has been caught on the hook.

One disadvantage of using a prior art limb line is that, because the limb line is not easily storable, fisherman typically cut a new length of line and attach a new hook to the line each time the fisherman wants to use a limb line. In addition, it can be an onerous task to check the limb lines for fish because of their locations along the shoreline and because they must each be pulled from the water to check their hooks for fish.

It would therefore be desirable to develop a limb line fishing device capable of securing a reusable line and a hook. It would also be desirable to develop a limb line fishing device with an indicator that can be used to determine at a distance whether a fish is caught on the hook.

### BRIEF SUMMARY OF THE INVENTION

The present invention is directed to a limb line fishing device comprising: (a) a length of fishing line; and (b) a hollow indicator tube, wherein said indicator tube slidably receives said fishing line.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of the limb line fishing device in the unlocked position.

FIG. 2 is a perspective view of the limb line fishing device in the unlocked position.

FIG. 3 is a top view of the second end of the limb line fishing device.

FIG. 4 is a perspective view of the limb line fishing device in the unlocked position.

FIG. 5 is a side view of the limb line fishing device in the locked position.

FIG. 6 is a perspective view of the limb line fishing device with the indicator tube in the down position.

FIG. 7 is a perspective view of the limb line fishing device with the indicator tube in the up position.

### DETAILED DESCRIPTION OF THE INVENTION

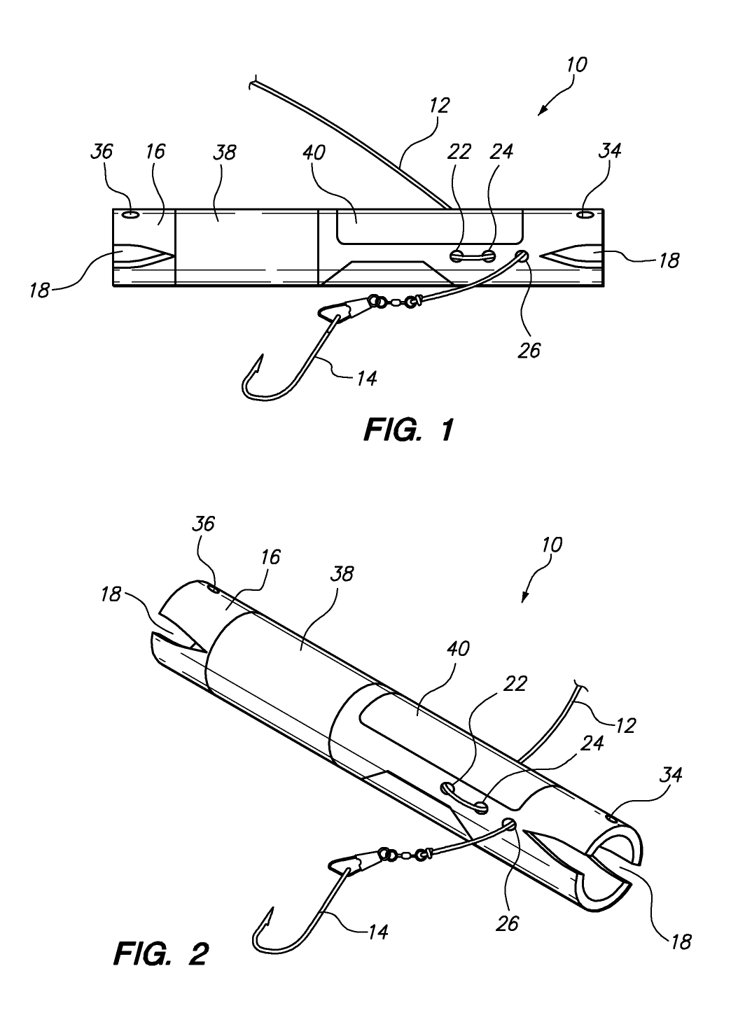

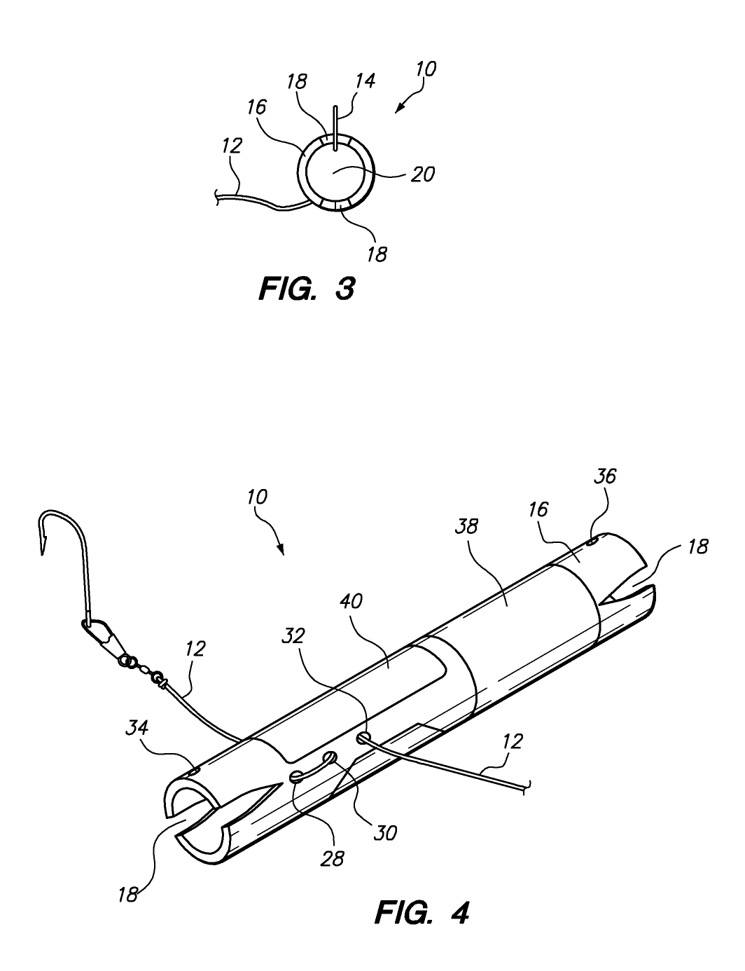

With reference to FIGS. 1-7, the preferred embodiments of the present invention may be described. As shown in FIGS. 1-2, the limb line fishing device 10 is comprised of a line 12, a hook 14, and an indicator tube 16. The line 12 is preferably a length of fishing line or a rope capable of supporting the weight of a fish. The hook 14 is a fishing hook of the type well-known to those skilled in the art. The indicator tube 16 is preferably made of PVC or another material that is similarly durable and light-weight, such as other types of plastic. The indicator tube 16 is hollow and preferably in the shape of a cylinder. As shown in FIGS. 1-5, each end of the indicator tube 16 preferably has two notches 18. In some embodiments, as shown in FIG. 3, a plug 20 is positioned inside and near each end of the indicator tube 16 made of PVC or foam. The indicator tube 16 is capable of floating in water.

On opposite surfaces of the indicator tube 16 are a series of three holes, preferably equally spaced apart, sized to slidably receive the line 12. As shown in FIGS. 1-2 and 4, the first surface of the indicator tube 16 comprises holes 22, 24, 26, while the second surface of the indicator tube comprises holes 28, 30, 32. The indicator tube 16 also has two single holes opposite one another at each end of the indicator tube 16 which are sized to slidably receive the line 12. As shown in FIGS. 1-2 and 4, the first end of the indicator tube 16 comprises holes 34, while the second end of the indicator tube 16 comprises holes 36. The exterior surface of the indicator tube 16 preferably has a reflective sticker 38 and a sticker 40 with identifying information about the owner of the fishing device 10, such as their name and fishing license number. The reflective sticker 38 aids the fisherman using the device 10 to located it in the dark.

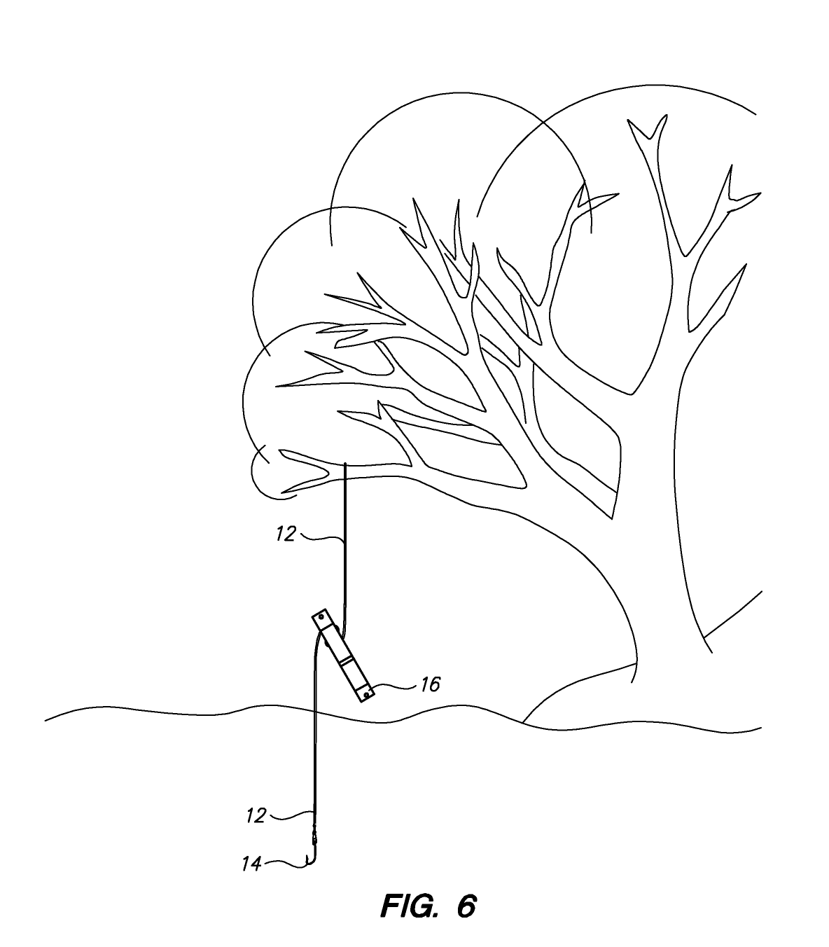

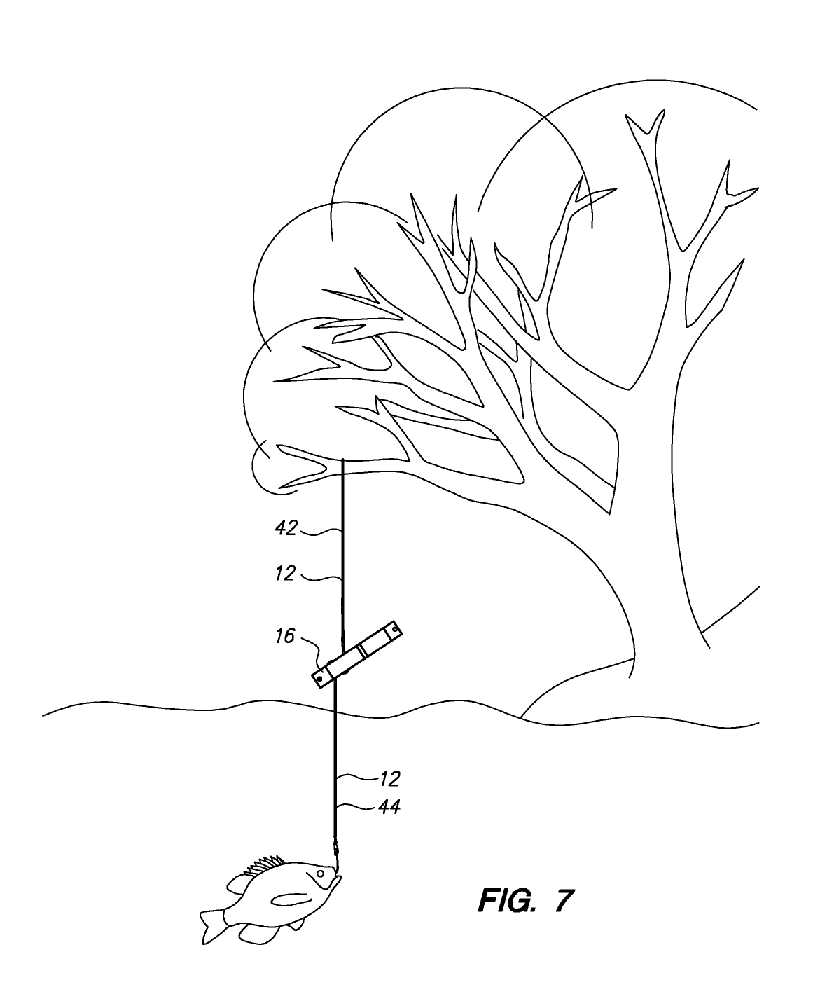

The line 12 and the indicator tube 16 are attached by threading the free end 42 of line 12 through holes 22, 24, 26, 28, 30, 32 of the indicator tube 16. The line 12 is first threaded through hole 26 into the interior of the indicator tube 16 and out through hole 28. The line 12 is then looped and threaded through hole 30 into the interior of the indicator tube 16 and out through hole 24. The line 12 is then looped and threaded through hole 22 into the interior of the indicator tube 16 and out through hole 32. As shown in FIGS. 6-7, in threading the line 12 through the holes 22, 24, 26, 28, 30, 32, the free end 42 and hook end 44 of the line 12 make an S-shape. By threading more of the free end 42 of the line 12 into hole 30 and pulling more of the hook end 44 of the line out of hole 26, the indicator tube 16 can be moved towards the free end 42 of the line 12. By doing the opposite, the indicator tube 16 can be moved towards the hook 14 on the line 12. Adjusting the position of the indicator tube 16 on the line 12 may be desirable depending on the depth of the water in which the device 10 is being used.

As shown in FIGS. 6-7, to use the limb line fishing device 10, the free end 42 of the line 12 is attached to a tree, stump, or similar fixed object in the vicinity of the water. The hook is then baited and lowered into the water. Because the entire length of the indicator tube 16 should be positioned above the surface of the water, the indicator tube 16 may require adjustment on the line 12 as previously described. The indicator tube 16 has an up position and a down position. Before a fish is caught on the hook 14, the indicator tube 16 is in the down position as shown in FIG. 6. Once a fish is caught on the hook 14, and downward tension is exerted on the line 12, the indicator tube 16 flips upward and converts to the up position as shown in FIG. 7. Because the hook 14 is below the surface of the water, and commonly unseen without removing it from the water, the position of the indicator tube 16 can be used to readily determine at a distance whether a fish has been caught. This feature can save considerable time of the fisherman in checking the line.

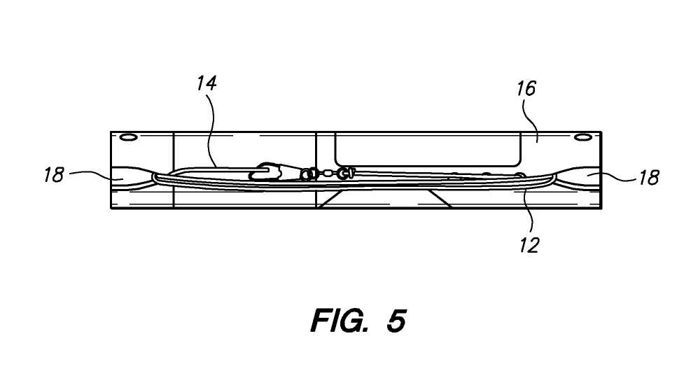

The indicator tube 16 also serves to securely store the line 12 and hook 14 when the device 10 is not in use. As shown in FIG. 5, the hook 14 can be received by notch 18 to prevent the hook being inadvertently damaged when the device 10 is not in use and also to prevent injury to those that may come into contact with the device 10. The line 12 can be wrapped lengthwise around the indicator tube 16 through the two notches 18. Once the line 12 has been wrapped around the indicator tube 16 as many times as possible, the remaining line 12 can be secured by threading it through either hole 34 or hole 36. In this regard, the device 10 has a locked position as shown in FIG. 5 and an unlocked position as shown in all the other figures.

The limb line fishing device 10 may be used to catch all types of fish and other water animals (e.g. alligators). Therefore, the size of the tube 16, the size and strength of the line 12, and the number and size of the holes 22, 24, 26, 28, 30, 32, 34, 36 may vary depending on the intended use of the device 10.

Although illustrative embodiments of the invention have been described in detail, it is to be understood that the present invention is not limited to those precise embodiments, and that various changes and modifications can be effected therein by one skilled in the art without departing from the scope and spirit of the invention as defined by the claims.

The present invention has been described with reference to certain preferred and alternative embodiments that are intended to be exemplary only and not limiting to the full scope of the present invention as set forth in the appended claims.

We claim:

1. A limb line fishing device comprising: (a) a length of fishing line comprising a first end and a second end; and (b) a hollow indicator tube comprising a first end and a second end, wherein said indicator tube slidably receives said fishing line.

2. The limb line fishing device of claim 1, wherein said first end of said indicator tube comprises a first notch and said second end of said indicator tube comprises a second notch.

3. The limb line fishing device of claim 1, wherein said indicator tube further comprising a reflector means.

4. The limb line fishing device of claim 2, wherein said first end of said fishing line is connected to a fishing hook.

5. The limb line fishing device of claim 1, further comprising a plurality of holes extending through said hollow indicator tube, wherein said fishing line is threaded through said plurality of holes.

6. The limb line fishing device of claim 1, wherein said indicator tube is adjustable along said length of fishing line.

7. The limb line fishing device of claim 1, wherein said second end of said fishing line is tied to a fixed object.

8. The limb line fishing device of claim 7, wherein said fixed object is a tree limb or a tree stump.

9. The limb line fishing device of claim 2, wherein said fishing line is wrapped longitudinally around said indicator tube when said limb line fishing device is in a locked position.

10. The limb line fishing device of claim 4, wherein said fishing hook engages said first notch of said indicator tube when said limb line fishing device is in a locked position.

11. The limb line fishing device of claim 1, wherein said indicator tube has an up position and a down position.

12. The limb line fishing device of claim 11, wherein said up position indicates a fish connected to said first end of said fishing line.

13. The limb line fishing device of claim 11, wherein said down position indicates no fish is connected to said first end of said fishing line.
